(19) United States
(12) Patent Application Publication
(10) Pub. No.: US 2025/0020084 A1
(43) Pub. Date: Jan. 16, 2025

(54) ENGINE BRAKING WITH FUEL INJECTION FOR INTERNAL COMBUSTION ENGINES

(71) Applicant: Cummins Inc., Columbus, IN (US)

(72) Inventors: James A. DODS, Durham (GB); Alan R. BENNETT, Indianapolis, IN (US)

(21) Appl. No.: 18/715,710

(22) PCT Filed: Nov. 28, 2022
(86) PCT No.: PCT/US2022/080487

§ 371 Date: Jun. 1, 2024

(30) Foreign Application Priority Data
Dec. 2, 2021 (GB) 2117400.8

(51) Int. Cl. F02D 13/04; F02D 13/02; F02D 41/00

(52) U.S. Cl. CPC F02D 13/04; F02D 13/0215; F02D 41/0007; F02D 41/008

(57) ABSTRACT

An internal combustion engine system includes an engine with a plurality of cylinders, a fueling system to provide fuel to the plurality of cylinders, an air intake system to provide air to the plurality of cylinders through respective ones of a plurality of intake valves, and an exhaust system to release exhaust gas from the plurality of cylinders through respective ones of a plurality of exhaust valves. During engine braking, an amount of fuel is injected into one or more cylinders involved in the engine braking during the compression stroke thereof to improve engine braking performance.

### CROSS-REFERENCE TO RELATED APPLICATION

The present application claims priority to UK Patent Application No. GB2117400.8 filed on Dec. 2, 2021, which is incorporated herein by reference.

### BACKGROUND

The present invention relates to operation of an internal combustion engine system, and more particularly, but not exclusively, relates to engine braking of the internal combustion engine.

Engine braking can be accomplished with variable geometry (VG) turbine inlets and/or by control an exhaust valve opening timing during the power stroke. Compression release braking utilizing one or more of the engine's cylinders can also be employed by which the engine is slowed via opening an exhaust valve during the power stroke of the piston of the one or more cylinders. However, current compression release braking strategies may not provide a desired amount of braking energy. Thus, there is a continuing demand for further contributions in this area of technology.

### SUMMARY

Certain embodiments of the present application includes unique systems, methods and apparatus to regulate operation of an internal combustion engine using a fuel injection during compression release braking for one or more cylinders in response to engine braking conditions. Other embodiments include unique apparatus, devices, systems, and methods involving the engine braking control of an internal combustion engine system using fuel injection during a compression stroke of one or more cylinders while controlling the valve train for four stroke and/or two stroke compression release braking using the one or more cylinders. The internal combustion engine can also be configured to provide exhaust gas recirculation during the compression release braking to further enhance the engine braking output.

This summary is provided to introduce a selection of concepts that are further described below in the illustrative embodiments. This summary is not intended to identify key or essential features of the claimed subject matter, nor is it intended to be used as an aid in limiting the scope of the claimed subject matter. Further embodiments, forms, objects, features, advantages, aspects, and benefits shall become apparent from the following description and drawings.

### BRIEF DESCRIPTION OF THE DRAWINGS

FIG. 1 is a schematic view of one embodiment of an internal combustion engine system operable to provide fuel injection during compression release braking.

FIG. 2 is a diagrammatic and schematic view of one embodiment of a cylinder of the internal combustion engine system of FIG. 1 and a schematic of a valve actuation mechanism for compression release braking and cylinder deactivation.

FIG. 3 is a flow diagram of one embodiment of a procedure for operation of the internal combustion engine system of FIG. 1 to provide compression release braking with fuel injection.

FIG. 4 is a graphical representation of an example nominal cam lobe profile for operating the intake valves and the exhaust valves of one or more of the cylinders of the internal combustion engine system of FIG. 1.

FIG. 5 is a graphical representation of an example four stroke compression release cam lobe profile for operating the intake valves and the exhaust valves of one or more of the cylinders of the internal combustion engine system of FIG. 1.

FIG. 6 is a graphical representation of an example two stroke compression release cam lobe profile for operating the one of the intake valves and one of the exhaust valves of one or more of the cylinders of the internal combustion engine system of FIG. 1 while the other of the intake valves and the other of the exhaust valves are deactivated.

### DETAILED DESCRIPTION OF REPRESENTATIVE EMBODIMENTS

While the present invention can take many different forms, for the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications of the described embodiments, and any further applications of the principles of the invention as described herein are contemplated as would normally occur to one skilled in the art to which the invention relates.

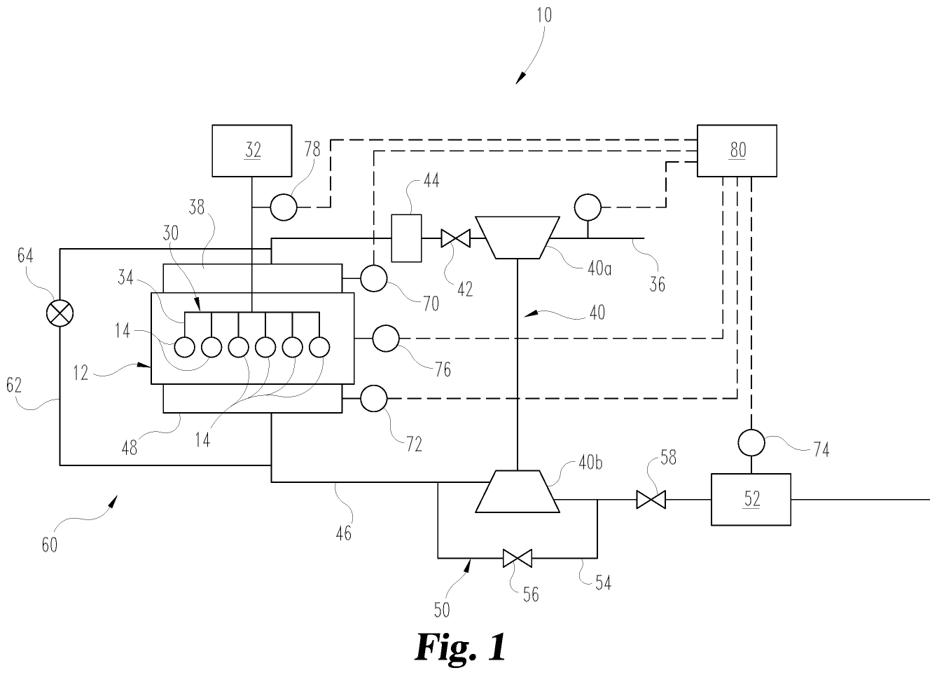

With reference to FIG. 1, an internal combustion engine system 10 includes a four stroke internal combustion engine 12 having a plurality of cylinders 14 that form combustion chambers housing pistons. Any engine type is contemplated, including compression ignition, spark-ignition, and combinations of these, so long as compression release braking is employed in response to certain braking conditions. System 10 is configured and operable to provide compression release braking via one or more of the cylinders 14 while employing an injection of fuel during the compression stroke of the one or more cylinders 14 involved in the compression release braking. The injected fuel is combusted during the compression stroke to create an increased negative torque, while the exhaust valve(s) are opened immediately after top-dead-center of the piston to avoid creating positive torque during the expansion stroke.

FIG. 1 illustrates the plurality of cylinders 14 in a configuration that includes six cylinders 14 in an in-line arrangement for illustration purposes only. Any number of cylinders and any arrangement of the cylinders in a single cylinder bank or multiple cylinder banks suitable for use in an internal combustion engine can be utilized. The number of cylinders 14 that can be included with engine 12 can range from two cylinders to eighteen or more.

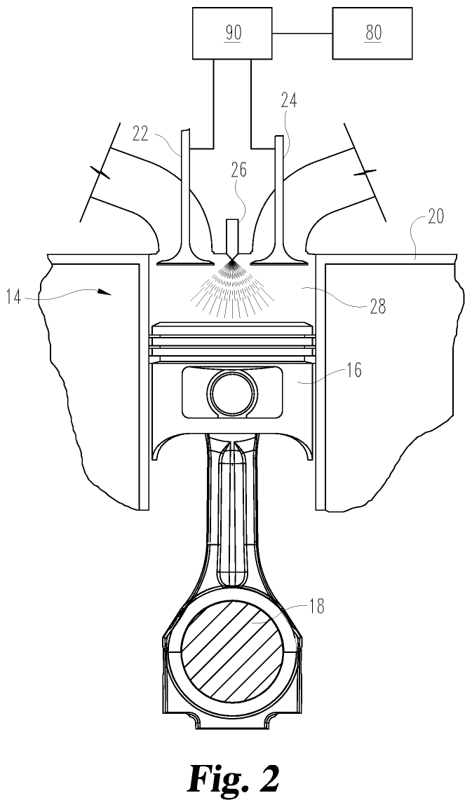

Furthermore, the following description at times will be in reference to one of the cylinders 14. It is to be realized that corresponding features in reference to the cylinder 14 described in FIG. 2 and at other locations herein can be present for all or a subset of the other cylinders 14 of engine 12 unless noted otherwise.

As shown in FIG. 2, the cylinder 14 houses a piston 16 that is operably attached to a crankshaft 18 that is rotated by reciprocal movement of piston 16 in a combustion chamber 28 of the cylinder 14. Within a cylinder head 20 of the cylinder 14, there is at least one intake valve 22, at least one exhaust valve 24, and a fuel injector 26 that provides fuel to the combustion chamber 28 formed by cylinder 14 between the piston 16 and the cylinder head 20. Furthermore, in the discussion that follows, each cylinder 14 may also include two intake valves 22 and two exhaust valves 24.

The term “four stroke” herein means the following four strokes—intake, compression, power, and exhaust—that the piston 16 completes during two separate revolutions of the engine's crankshaft 18, which is a combustion cycle. A stroke begins either at a top dead center (TDC) when the piston 16 is at the top of cylinder head 20 of the cylinder 14, or at a bottom dead center (BDC), when the piston 16 has reached its lowest point in the cylinder 14.

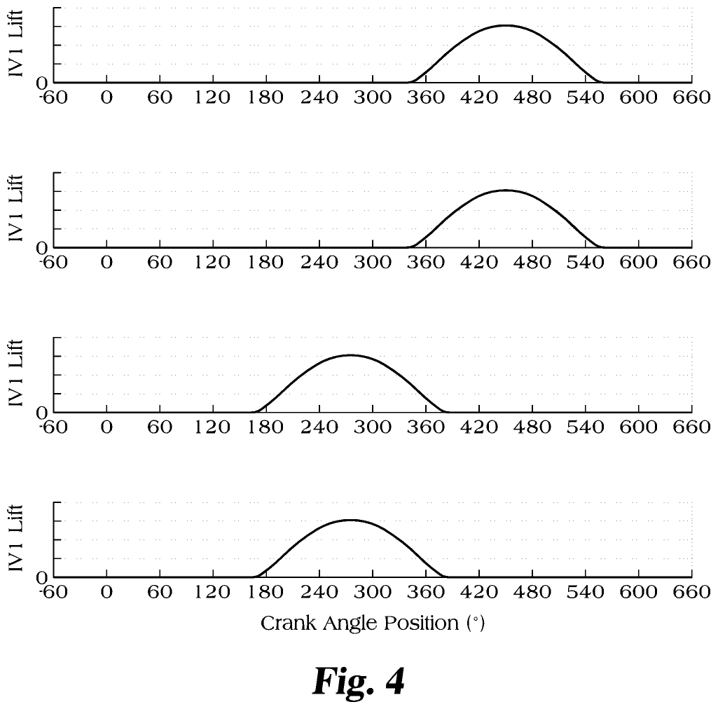

Referring further to FIG. 4, there is shown example of nominal intake and exhaust valve opening and closing profiles during a combustion cycle for the two intake valves (IV1 and IV2) and the two exhaust valves (EV1 and EV2). During the intake strokes for IV1 and IV2, the piston 16 descends away from cylinder head 20 of the cylinder 14 to a bottom (not shown) of the cylinder 14, thereby reducing the pressure in the combustion chamber 28 of the cylinder 14. A combustion charge is created in the combustion chamber 28 by an intake of air through the intake valves 22 when the intake valves 22 are opened.

The fuel from the fuel injector 26 is supplied by, for example, a high pressure common-rail system 30 (FIG. 1) that is connected to the fuel tank 32. Fuel from the fuel tank 32 is suctioned by a fuel pump (not shown) and fed to the common-rail fuel system 30. The fuel fed from the fuel pump is accumulated in the common-rail fuel system 30, and the accumulated fuel is supplied to the fuel injector 26 of each cylinder 14 through a fuel line 34. The accumulated fuel in common rail system can be pressurized to boost and control the fuel pressure of the fuel delivered to combustion chamber 28 of each cylinder 14. However, any type of fuel delivery system is contemplated so long as fuel can be injected into one or more cylinders 14 during compression release braking.

During the compression stroke in a non-engine braking mode of operation, the intake valves 22 and the exhaust valves 24 are generally closed as shown by IV1, IV2 and EV1, EV2 in FIG. 4. The piston 16 returns toward TDC and fuel is injected near TDC in the compressed air in a main injection event, and the compressed fuel-air mixture ignites in the combustion chamber 28 after a short delay. In the instance where the engine 12 is a diesel engine, this results in the combustion charge being ignited. The ignition of the air and fuel causes a rapid increase in pressure in the combustion chamber 28, which is applied to the piston 16 during its power stroke toward the BDC. Combustion phasing in combustion chamber 28 is calibrated so that the increase in pressure in combustion chamber 28 pushes piston 16, providing a net positive in the force/work/power of piston 16.

During the exhaust stroke, the piston 16 is returned toward TDC while the exhaust valves 24 are open, as shown by EV1 and EV2 in FIG. 4. This action discharges the burnt products of the combustion of the fuel in the combustion chamber 28 and expels the spent fuel-air mixture (exhaust gas) out through the exhaust valves 24. The next combustion cycle occurs using these same intake and exhaust valve opening closing profiles, unless an engine braking condition is determined, as discussed further below.

Referring back to FIG. 1, the intake air flows through an intake passage 36 and intake manifold 38 before reaching the intake valves 22. The intake passage 36 may be connected to a compressor 40a of a turbocharger 40 and an intake throttle 42. The intake air can be purified by an air cleaner (not shown), compressed by the compressor 40a and then aspirated into the combustion chamber 28 through the intake throttle 42. The intake throttle 42 can be controlled to influence the air flow into the cylinder and, as discussed further below, to vary the engine braking provided during compression release braking operation.

The intake passage 36 can be provided with a cooler 44 that is located, for example, downstream of the compressor 40a. In one example, the cooler 44 can be a charge air cooler (CAC). In this example, the compressor 40a can increase the temperature and pressure of the intake air, while the cooler 44 increases a charge density and provides more air to the cylinders. In another example, the cooler 44 can be a low temperature aftercooler (LTA). The cooler 44 configured as a CAC can use air as the cooling media, while a cooler 44 configured as a LTA can use coolant as the cooling media.

The exhaust gas flows out from the combustion chamber 28 into an exhaust passage 46 from an exhaust manifold 48 that connects the cylinders 14 to exhaust passage 46. The exhaust passage 46 is connected to a turbine 40b of the turbocharger 40 and then to an aftertreatment system 52. The exhaust gas that is discharged from the combustion chamber 28 drives the turbine 40b to rotate. Turbine 40b can include a variable geometry or other size adjustable inlet to control the exhaust flow therethrough. In an embodiment, a wastegate 50 can be provided that is a device that enables part of the exhaust gas to by-pass the turbine 40b through a passageway 54. The wastegate 50 can include a control valve 56 that can be an open/closed (two position) type of valve, or a full authority valve allowing control over the amount of by-pass flow, or anything between. The exhaust passage 46 can further or alternatively include an exhaust throttle 58 for adjusting the flow of the exhaust gas through the exhaust passage 46. The exhaust gas then enters the aftertreatment system 52.

Optionally, a part of the exhaust gas can be recirculated into the intake system via an EGR system 60 including an EGR passage 62. The EGR passage 62 can be connected the exhaust passage 46 upstream of the turbine 40b to the intake passage 36 downstream of the intake air throttle 42. Alternatively or additionally, a low pressure EGR system (not shown) can be provided downstream of turbine 40b and upstream of compressor 40a. An EGR valve 64 can be provided for regulating the EGR flow through the EGR passage 62. The EGR passage 62 can be further provided with an EGR cooler and a bypass around the EGR cooler (not shown.)

The aftertreatment system 52 may include one or more devices useful for handling and/or removing material from exhaust gas that may be harmful constituents, including carbon monoxide, nitric oxide, nitrogen dioxide, hydrocarbons, and/or soot in the exhaust gas. In some examples, the aftertreatment system 52 can include at least one of a catalytic device and a particulate matter filter. The catalytic device can be a diesel oxidation catalyst (DOC) device, ammonia oxidation (AMOX) catalyst device, a selective catalytic reduction (SCR) device, three-way catalyst (TWC), lean NOX trap (LNT) etc. The reduction catalyst can include any suitable reduction catalysts, for example, a urea selective reduction catalyst. The particulate matter filter can be a diesel particulate filter (DPF), a partial flow particulate filter (PFF), etc. A PFF functions to capture the particulate matter in a portion of the flow; in contrast the entire exhaust gas volume passes through the particulate filter.

A controller 80 is provided to receive data as input from various sensors, and send command signals as output to various actuators. Some of the various sensors and actuators that may be employed are described in detail below. The controller 80 can include, for example, a processor, a memory, a clock, and an input/output (I/O) interface.

The system 10 includes various sensors such as an intake manifold pressure/temperature sensor 70, an exhaust manifold pressure/temperature sensor 72, one or more aftertreatment sensors 74 (such as a differential pressure sensor, temperature sensor(s), pressure sensor(s), constituent sensor(s)), engine sensors 76 (which can detect the air/fuel ratio of the air/fuel mixture supplied to the combustion chamber, a crank angle, the rotation speed of the crankshaft, etc.), and a fuel sensor 78 to detect the fuel pressure and/or other properties of the fuel, common rail 38 and/or fuel injector 26. Any other sensors known in the art for an engine system are also contemplated.

System 10 can also include various actuators for opening and closing the intake valves 22, for opening and closing the exhaust valves 24, for injecting fuel from the fuel injector 26, for opening and closing the inlet to the turbine 40b or the wastegate valve 56, for the intake throttle 42, the EGR valve 64, and/or for the exhaust throttle 58. The actuators are not illustrated in FIG. 1, but one skilled in the art would know how to implement the mechanism needed for each of the components to perform the intended function. Furthermore, in one embodiment, the actuators for opening and closing the intake and exhaust valves 22, 24 is a valve actuation (VA) system 90, such as shown schematically in FIG. 2.

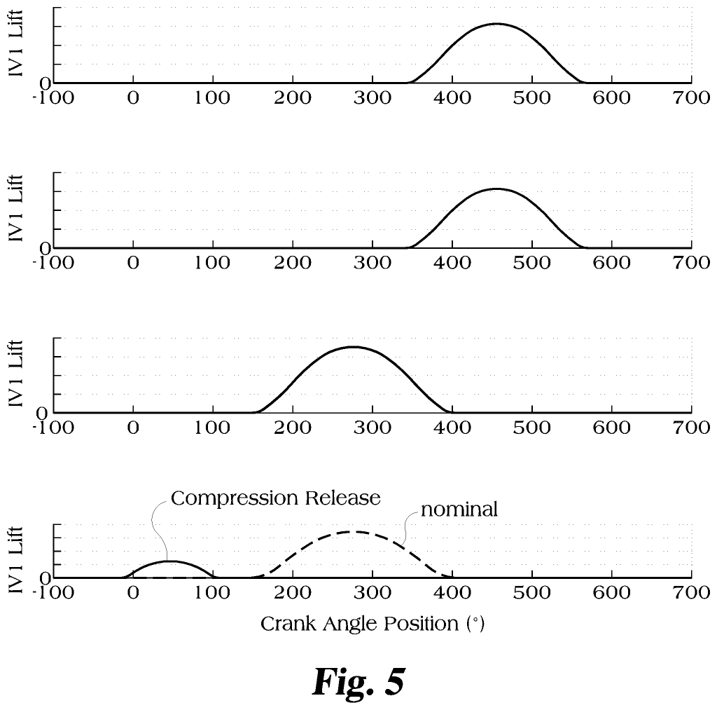

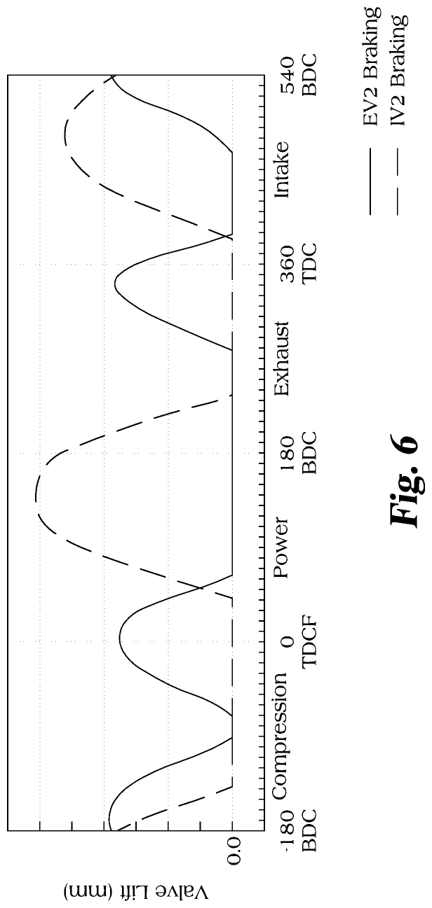

The VA system 90 can include any system or components configured and/or operable to provide cylinder deactivation of one or more of the cylinders 14 in response to cylinder deactivation conditions and in response to engine braking conditions. The same architecture can be used for cylinder deactivation and engine braking, although separate architectures are not precluded. For example, the VA system 90 can be configured to, for all or a subset of cylinders 14, engage with cam lobes or other valve lifting structures associated with the intake and the exhaust valves to produce a nominal lift profile such as shown in FIG. 4, and be switched or configured to produce one or more compression release braking profiles. For example, the cam lobes and valve lifting structure can produce a four stroke compression release braking profile as shown in FIG. 5. In another example, the cam lobes and valve lifting structure can utilize cylinder deactivation (CDA) hardware to produce a zero lift profile for one of the intake valves and the exhaust valves 24, and an alternate lift profile for the other of the intake and exhaust valves, such as shown in FIG. 6, for two stroke compression release braking.

Under four stroke compression release braking, IV1, IV2 and EV1 can continue to operate according to their nominal opening and closing profile. However, as shown in FIG. 5, EV2 is opened at the end of the compression stroke and during the power stroke for a smaller lift and shorter duration as compared to its nominal lift profile during the exhaust stroke, as shown in FIG. 4 and by the dashed lines in FIG. 5.

Under two stroke compression release braking, IV1 and EV1 are deactivated so that zero lift of produced during each cycle of the cylinder(s) providing the compression release braking. As shown in FIG. 6, the opening and closing profiles of IV2 and EV2 are modified to produce compression release braking. IV2 opens during the intake stroke, and also opens during the power stroke. The opening time can be such that IV2 remains open during the intake stroke and until the start of the compression stroke, i.e. after bottom-dead-center of the intake stroke. For the second opening event, IV2 can also remain open during the power stroke and until the start of the exhaust stroke, i.e. after bottom dead center of the power stroke. EV2 opens during the compression stroke, and then also opens during the exhaust stroke. The opening time can be such that EV2 opens near top-dead-center of the compression stroke and before the compression release fuel injection event, and remains open during the remainder of the compression stroke and during the start of the compression stroke, i.e. after top-dead-center of the compression stroke. For the second opening event for EV2 during the exhaust stroke, EV2 remains open until the start of the intake stroke, i.e. after top-dead-center of the exhaust stroke. By providing two stroke compression braking on one or more of the cylinders 14, a braking amount can be provided that about double the braking effort produced by four stroke compression braking one the same number of cylinders 14.

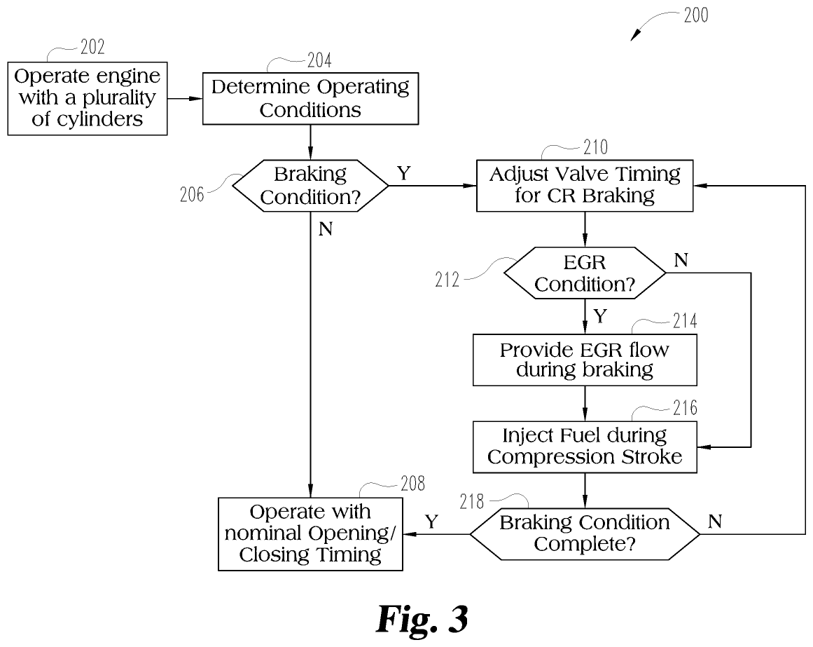

Referring to FIG. 3, a flow diagram of one embodiment of a procedure 200 for compression release engine braking is shown. The procedure 200 includes an operation 202 for operating the internal combustion engine system 10, such as internal combustion engine 12 with a plurality of cylinders 14 that receive a charge flow from intake passage 36. Furthermore, at least a portion of the plurality of cylinders 14 receives fuel from fuel system 30 in response to a vehicle or engine speed request.

Procedure 200 continues at operation 204 to determine operating conditions for the internal combustion engine. The operating conditions can include any one or more parameters indicative of an engine braking condition. Procedure 200 continues at conditional 206 to determine if an engine braking condition or request is absent or present. The determination of the engine braking request being present can result from, for example, an input from a vehicle operator such as a brake pedal position, an accelerator pedal position, or engine brake request input switch. If conditional 206 is negative, procedure 200 continues at operation 208 to operate the cylinders 214, such as by employing their nominal opening and closing profiles for the intake valves 22 and exhaust valves 24, as shown in FIG. 4, or other selectable opening and closing profile. Procedure 200 can restart from operation 208 and/or continue to monitor for operating conditions indicating an engine braking condition.

If conditional 206 is positive, procedure 200 continues at operation 210 to adjust the intake and/or exhaust valve timing to provide compression release (CR) braking with one or more of the cylinders 14. The compression release braking can be applied to one or more of the cylinders 14 using four stroke compression release braking with the exhaust valve 24 as shown in FIG. 5, or using two stroke compression release braking with the intake valves 22 and the exhaust valves 24 as shown in FIG. 6. For two stroke compression braking, the cylinder(s) 14 involved in the braking can have one of the intake valves IV1 and one of the exhaust valves EV1 deactivated during each cycle of the cylinder(s) providing the compression release braking. The other intake valve IV2 is opened during the power stroke and during the intake stroke, and the other exhaust valve EV2 is opened before top-dead-center of the compression stroke and remain open for a portion of the power stroke. Exhaust valve EV2 can also be opened before top-dead-center exhaust stroke and remain open for a portion of the intake stroke. The zero lifts for the deactivated intake valve IV1 and exhaust valve EV1 can be provided by, for example, cylinder deactivation hardware that provides a zero lift profile. The remaining cylinders 14, if any, that are not involved in the compression release braking can operate according to their nominal opening and closing profiles.

Procedure 200 continues at conditional 212 to determine if EGR conditions are present. For example, EGR conditions may indicate that EGR flow is desirable in response to certain operating conditions to boost intake pressure for compression release braking. In one embodiment, the EGR conditions are determined in response to a pressure condition at an inlet of turbocharger 40a. If the turbine inlet pressure condition is approaching or exceeding a pressure limit, the EGR valve 64 can be opened at operation 214 to provide EGR flow and reduce pressure at the turbine inlet while boosting intake manifold pressure. Another EGR condition can be determined in response to an exhaust manifold pressure, engine speed, or other condition in which EGR flow is desirable during engine braking in order to produce more intake flow and increase cylinder pressure. If the EGR condition is satisfied at conditional 212, procedure 200 continues at operation 214 to provide EGR flow during engine braking. Embodiments of the present disclosure in which the EGR flow is not provided and/or the EGR condition is not determined during compression release braking are also contemplated.

From operation 214, or from conditional 212 if negative, procedure 200 continues at operation 216. Operation 216 includes injecting fuel into the one or more of the cylinders involved in producing the compression release braking. Fuel is injected during the compression stroke of the piston of the cylinders 14 used for compression release braking. The fuel can be injected any time the piston is located between bottom-dead-center and top-dead-center of the compression stroke of the cylinder(s) 14. In an embodiment, fuel is injected between 20 and 50 degrees before top-dead-center of the compression stroke. In another embodiment, fuel is injected between 25 and 45 degrees before top-dead-center of the compression stroke. In an embodiment, fuel is injected at or about 35 degrees before top-dead-center of the compression stroke. The injected fuel amount can be any suitable fuel amount, ranging, for example, from 5 mg to 60 mg of fuel.

Procedure 200 continues at conditional 218 to determine if the braking condition is complete or satisfied. If conditional 218 is negative, procedure 200 can return to operation 210 to continue the engine braking operations. If conditional 218 is positive, then procedure 200 can continue at operation 208.

During operation of the internal combustion engine system 10, the controller 80 can receive information from the various sensors listed above through I/O interface(s), process the received information using a processor based on an algorithm stored in a memory of the controller 80, and then send command signals to the various actuators through the I/O interface. For example, the controller 80 can receive information regarding an engine braking request, a vehicle or engine speed request, and/or an engine load condition. The controller 80 is configured to process the requests and/or input(s), and then based on the control strategy, such as procedure 200 discussed above, send one or more command signals to one or more actuators to provide compression release braking. Controller 80 also controls fuel injection timing and amount to boost compression release braking as discussed above. Controller 80 may also control EGR flow to increase in-cylinder pressure during compression release braking in response to certain operating conditions.

The controller 80 can be configured to implement the disclosed compression release braking strategies using VA system 90, fueling system 30, and EGR system 60. In one embodiment, the disclosed method and/or controller configuration include the controller 80 providing an engine braking command and a fuel injection command in response to an engine braking request that is based on one or more signals from one or more of the plurality of sensors described above for internal combustion engine system 10. The engine braking commands control VA mechanism 90 to provide the desired intake and exhaust valve closure or opening and closing timing, and the fueling commands provide a fuel amount injected via injector 26 into the cylinder(s) involved in the compression release braking during the compression stroke thereof.

The control procedures implemented by the controller 80 can be executed by a processor of controller 80 executing program instructions (algorithms) stored in the memory of the controller 80. The descriptions herein can be implemented with internal combustion engine system 10. In certain embodiments, the internal combustion engine system 10 further includes a controller 80 structured or configured to perform certain operations to control internal combustion engine system 10 in achieving one or more target conditions. In certain embodiments, the controller forms a portion of a processing subsystem including one or more computing devices having memory, processing, and communication hardware. The controller may be a single device or a distributed device, and the functions of the controller 80 may be performed by hardware and/or by instructions encoded on a computer readable medium.

In certain embodiments, the controller 80 includes one or more modules structured to functionally execute the operations of the controller. The description herein including modules emphasizes the structural independence of the aspects of the controller, and illustrates one grouping of operations and responsibilities of the controller. Other groupings that execute similar overall operations are understood within the scope of the present application. Modules may be implemented in hardware and/or software on a non-transient computer readable storage medium, and modules may be distributed across various hardware or other computer components.

Certain operations described herein include operations to interpret or determine one or more parameters. Interpreting or determining, as utilized herein, includes receiving values by any method known in the art, including at least receiving values from a datalink or network communication, receiving an electronic signal (e.g. a voltage, frequency, current, or PWM signal) indicative of the value, receiving a software parameter indicative of the value, reading the value from a memory location on a non-transient computer readable storage medium, receiving the value as a run-time parameter by any means known in the art, and/or by receiving a value by which the interpreted or determined parameter can be calculated, and/or by referencing a default value that is interpreted or determined to be the parameter value.

Various aspects of the present disclosure are contemplated as described in the claims. According to one aspect, a method includes operating an internal combustion engine system including an internal combustion engine with a plurality of cylinders that receive a charge flow for combustion of a fuel provided to the plurality of cylinders. At least a portion of the plurality of cylinders are operable to be deactivated in response to a cylinder deactivation condition. The internal combustion engine is braked in response to a braking condition. Braking the internal combustion engine includes adjusting an exhaust valve opening and closing timing of one or more of the portion of the plurality of cylinders configured to be able to be deactivated to provide compression release braking after injecting fuel in the one or more of the portion of the cylinders during a compression stroke thereof in response to the braking condition.

In an embodiment, braking the internal combustion engine includes adjusting both the exhaust valve opening and closing timing and an intake valve opening and closing timing of each of the one or more of the portion of the plurality of cylinders to provide compression release braking.

In an embodiment, braking the internal combustion engine, for each cycle of the one or more of the portion of the plurality of cylinders during the compression release braking, includes: deactivating a first intake valve and a first exhaust valve thereof; opening a second intake valve thereof during the compression stroke and during the power stroke; and opening a second exhaust valve thereof before top-dead-center of the compression stroke and before top dead-center of the exhaust stroke.

In an embodiment, the internal combustion engine receives the charge flow from an intake system connected to an EGR system. The method includes providing EGR flow from the EGR system to the one or more of the portion of the plurality of cylinders during compression release braking of the internal combustion engine.

In an embodiment, during compression release braking, the fuel is injected about 35 degrees before top dead center of the compression stroke of the one or more of the portion of the cylinders. In embodiment, the fuel is injected 20 to 50 degrees before top dead center of the compression stroke. In an embodiment, the fuel is injected 25 to 45 degrees before top dead center of the compression stroke. In an embodiment, the fuel injected during the compression stroke combusts to increase in-cylinder pressure of the one or more of the portion of the cylinders during compression release braking.

According to another aspect, a system includes an internal combustion engine including a plurality of cylinders that receive a charge flow from an intake system and an exhaust system for receiving exhaust gas produced by combustion of a fuel in the plurality of cylinders. A valve actuation mechanism is configured to control an opening and closing timing of exhaust valves and intake valves associated with the plurality of cylinders. A controller is operable to determine a braking condition. In response to the braking condition, the controller is configured to adjust an exhaust valve opening and closing timing and an intake valve opening and closing timing of one or more of the plurality of cylinders via the valve actuation mechanism to produce two stroke compression release braking, and inject fuel into the one or more of a plurality of cylinders of the internal combustion engine providing compression release braking during a compression stroke thereof.

In an embodiment, the controller is configured to adjust the exhaust valve opening and closing timing and the intake valve opening and closing timing of multiple ones of the plurality of cylinders to provide compression release braking in response to the braking condition.

In an embodiment, an EGR system connects the exhaust system and the intake system, and controller is configured to provide an EGR flow to the one or more of the plurality of cylinders during the two stroke compression release braking. The controller is configured to provide the EGR flow in response to a pressure condition at a turbocharger inlet during the compression release braking.

In an embodiment, the valve actuation mechanism is configured to deactivate the one or more of the plurality of cylinders in response to a cylinder deactivation condition.

In an embodiment, during each cycle of the two stroke compression release braking for each of the one or more of the plurality of cylinders the valve actuation mechanism deactivates a first intake valve and a first exhaust valve thereof; opens a second intake valve thereof during the compression stroke and during the power stroke; and opens a second exhaust valve thereof before top-dead-center of the compression stroke and before top dead-center of the exhaust stroke.

According to another aspect, an apparatus includes a controller configured to receive signals from a plurality of sensors associated with operation of an internal combustion engine. The controller is configured to determine a braking condition and, in response to the braking condition, provide an engine braking command that adjusts an exhaust valve opening and closing timing and an intake valve opening and closing timing of one or more of the plurality of cylinders to produce two stroke compression release braking, and injects fuel into the one or more of a plurality of cylinders of the internal combustion engine providing compression release braking during a compression stroke thereof.

In an embodiment, the controller is configured to deactivate the one or more of the plurality of cylinders in response to a cylinder deactivation condition.

In an embodiment, during each cycle of the two stroke compression release braking for each of the one or more of the plurality of cylinders, the engine braking command deactivates a first intake valve and a first exhaust valve thereof; opens a second intake valve thereof during the compression stroke and during the power stroke; and opens a second exhaust valve thereof before top-dead-center of the compression stroke and before top dead-center of the exhaust stroke.

In an embodiment, engine braking command injects the fuel about 35 degrees before top dead center of the compression stroke during the two stroke compression release braking. In an embodiment, the engine braking command injects fuel 20 to 50 degrees before top dead center of the compression stroke during the two stroke compression release braking.

While the invention has been illustrated and described in detail in the drawings and foregoing description, the same is to be considered as illustrative and not restrictive in character, it being understood that only certain exemplary embodiments have been shown and described. Those skilled in the art will appreciate that many modifications are possible in the example embodiments without materially departing from this invention. Accordingly, all such modifications are intended to be included within the scope of this disclosure as defined in the following claims.

In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A method, comprising:
operating an internal combustion engine system including an internal combustion engine with a plurality of cylinders that receive a charge flow for combustion of a fuel provided to the plurality of cylinders, wherein at least a portion of the plurality of cylinders are operable to be deactivated in response to a cylinder deactivation condition; and
braking the internal combustion engine in response to a braking condition, wherein braking the internal combustion engine includes adjusting an exhaust valve opening and closing timing of one or more of the portion of the plurality of cylinders configured to be able to be deactivated to provide compression release braking after injecting fuel in the one or more of the portion of the cylinders during a compression stroke thereof in response to the braking condition.

2. The method of claim 1, wherein braking the internal combustion engine includes adjusting both the exhaust valve opening and closing timing and an intake valve opening and closing timing of each of the one or more of the portion of the plurality of cylinders to provide compression release braking.

3. The method of claim 1, wherein braking the internal combustion engine, for each cycle of the one or more of the portion of the plurality of cylinders during the compression release braking, includes:
deactivating a first intake valve and a first exhaust valve thereof;
opening a second intake valve thereof during the compression stroke and during the power stroke; and
opening a second exhaust valve thereof before top-dead-center of the compression stroke and before top dead-center of the exhaust stroke.

4. The method of claim 1, wherein the internal combustion engine receives the charge flow from an intake system connected to an exhaust gas recirculation (EGR) system.

5. The method of claim 4, further comprising:
providing EGR flow from the EGR system to the one or more of the portion of the plurality of cylinders during compression release braking of the internal combustion engine.

6. The method of claim 1, wherein, during compression release braking, the fuel is injected about 35 degrees before top dead center of the compression stroke of the one or more of the portion of the cylinders.

7. The method of claim 1, wherein, during compression release braking, the fuel is injected 20 to 50 degrees before top dead center of the compression stroke of the one or more of the portion of the cylinders.

8. The method of claim 1, wherein, during compression release braking, the fuel is injected 25 to 45 degrees before top dead center of the compression stroke of the one or more of the portion of the cylinders.

9. The method of claim 1, wherein the fuel injected during the compression stroke combusts to increase in-cylinder pressure of the one or more of the portion of the cylinders during compression release braking.

10. A system, comprising:
an internal combustion engine including a plurality of cylinders that receive a charge flow from an intake system and an exhaust system for receiving exhaust gas produced by combustion of a fuel in the plurality of cylinders;
a valve actuation mechanism configured to control an opening and closing timing of exhaust valves and intake valves associated with the plurality of cylinders; and
a controller operable to determine a braking condition, wherein the controller, in response to the braking condition, is configured to:
adjust an exhaust valve opening and closing timing and an intake valve opening and closing timing of one or more of the plurality of cylinders via the valve actuation mechanism to produce two stroke compression release braking; and
inject fuel into the one or more of a plurality of cylinders of the internal combustion engine providing compression release braking during a compression stroke thereof.

11. The system of claim 10, wherein the controller is configured to adjust the exhaust valve opening and closing timing and the intake valve opening and closing timing of multiple ones of the plurality of cylinders to provide compression release braking in response to the braking condition.

12. The system of claim 10, further comprising an exhaust gas recirculation (EGR) system connecting the exhaust system and the intake system, and controller is configured to provide an EGR flow to the one or more of the plurality of cylinders during the two stroke compression release braking.

13. The system of claim 12, wherein the controller is configured to provide the EGR flow in response to a pressure condition at a turbocharger inlet during the compression release braking.

14. The system of claim 10, wherein the valve actuation mechanism is configured to deactivate the one or more of the plurality of cylinders in response to a cylinder deactivation condition.

15. The system of claim 10, wherein during each cycle of the two stroke compression release braking for each of the one or more of the plurality of cylinders the valve actuation mechanism:
deactivates a first intake valve and a first exhaust valve thereof;
opens a second intake valve thereof during the compression stroke and during the power stroke; and
opens a second exhaust valve thereof before top-dead-center of the compression stroke and before top dead-center of the exhaust stroke.

16. An apparatus, comprising:
a controller configured to receive signals from a plurality of sensors associated with operation of an internal combustion engine, wherein the controller is configured to determine a braking condition and, in response to the braking condition, provide an engine braking command that:
adjusts an exhaust valve opening and closing timing and an intake valve opening and closing timing of one or more of the plurality of cylinders to produce two stroke compression release braking; and
injects fuel into the one or more of a plurality of cylinders of the internal combustion engine providing compression release braking during a compression stroke thereof.

17. The apparatus of claim 16, wherein the controller is configured to deactivate the one or more of the plurality of cylinders in response to a cylinder deactivation condition.

18. The apparatus of claim 17, wherein during each cycle of the two stroke compression release braking for each of the one or more of the plurality of cylinders the engine braking command:
deactivates a first intake valve and a first exhaust valve thereof;
opens a second intake valve thereof during the compression stroke and during the power stroke; and
opens a second exhaust valve thereof before top-dead-center of the compression stroke and before top dead-center of the exhaust stroke.

19. The apparatus of claim 16, wherein the engine braking command injects the fuel about 35 degrees before top dead center of the compression stroke during the two stroke compression release braking.

20. The apparatus of claim 16, wherein the engine braking command injects fuel 20 to 50 degrees before top dead center of the compression stroke during the two stroke compression release braking.
